(19) United States
(12) Patent Application Publication
(10) Pub. No.: US 2023/0273629 A1
(43) Pub. Date: Aug. 31, 2023

(54) REMOTELY CONTROLLABLE WATER METER AND RELATED MONITORING SYSTEM AND CONTROLLING METHOD

(71) Applicant: DROPMI S.R.L., Roma (IT)

(72) Inventors: Giovanni PAPALEO, Roma (IT); Claudio COSENTINO, Roma (IT); Massimo COLOCCI, Roma (IT); Anna VARRIALE, Roma (IT); Michele SARTORI, Roma (IT); Samuel LOYSON, Paris La Défense (FR); Hugues HAEFFNER, Paris La Défense (FR); Pierre-Emmanuel LOUVET, Paris La Défense (FR); Nicolas PREGO, Paris La Défense (FR); Eléonore DUPONT, Paris La Défense (FR)

(21) Appl. No.: 18/011,930

(22) PCT Filed: Jun. 23, 2021
(86) PCT No.: PCT/IB2021/055542

§ 371 Date: Dec. 21, 2022

(30) Foreign Application Priority Data
Jun. 24, 2020 (IT) 102020000015196

(51) Int. Cl. G05D 7/06; E03B 7/07; G05B 19/416

(52) U.S. Cl. CPC G05D 7/0635; E03B 7/072; E03B 7/075; G05B 19/416; G05B 2219/45006

(57) ABSTRACT

Water meter, configured to supply water at a customer site, including:
a water flow regulating valve configured to assume at least three predetermined positions including a fully open position configured to let a maximum water flow to be supplied at said customer site, a closed position configured to prevent water flow to be supplied at said customer site, and at least one intermediate position configured to let at least one respective intermediate water flow, lower than the maximum water flow, to be supplied at said customer site;
an actuator operatively coupled to the water flow regulating valve and configured to automatically set a current position of the water flow regulating valve selected out of said at least three predetermined positions;
a pressure sensor configured to detect water pressure upstream of the water flow regulating valve;
a processing and communicating unit, operatively connected to the actuator, that is configured to communicate with a remote water provider centre to receive water flow regulating valve setting data, wherein said processing and communicating unit is further operatively connected to said pressure sensor to receive water pressure data sensed by said pressure sensor;
   wherein said processing and communicating unit is configured to control the actuator to cause the water flow regulating valve to assume said current position corresponding to valve position setting data that are correlated to said water flow regulating valve setting data and to said water pressure upstream of said water flow regulating valve detected by said pressure sensor, wherein said water flow regulating valve setting data are in turn correlated to a customer profile.

### TECHNICAL FIELD

The present invention concerns a water meter that allows in a simple, fast, reliable, flexible, effective and efficient way to dynamically control supply of water at a customer site at least on the basis of remote water flow regulating valve setting data correlated to a customer profile.

The present invention further concerns a system of monitoring water supply at a plurality of customer sites and a computer-implemented method of dynamically controlling a water supply at a customer site, as well as computer programs and computer-readable storage media implementing the computer-implemented method.

### STATE OF THE ART

It is known that water meters are used by water providers to monitor water consumption at customer sites, such as for instance: a single residential apartment, where water is supplied to the customer according to a domestic contract; a residential condominium having a certain number of domestic users, where water is supplied to the customer according to a residential condominium contract; a restaurant; a hospital; a prison; a medical office; a public administration office; a school or university; a factory.

A problem with the prior art water meter is that they are not dynamically controlled in a flexible, effective and efficient manner so as to regulate water supply at one or more different sites in reaction to specific circumstances which can vary in time.

Document WO 2019/220332 A1 discloses a prepaid water management system comprising a smart valve controller having a valve to control water flow through a water carrying conduit and a water meter to measure the water flow volume through the water carrying conduit, which wirelessly communicate with each other and with a user interface allowing a user to view data regarding water use and to enter purchased water credits, wherein smart valve controller either fully opens or fully closes the valve depending on whether a sufficient or insufficient water credit is available to the user.

Documents U.S. Pat. No. 8,719,187 B2 and EP 351350 A1 disclose other prior art water meters, while document WO 2015/154135 A1 discloses a control system allowing a user to control water flow at user's premises.

However, these prior art systems do not allow to dynamically control the smart valve controller in a flexible, effective and efficient manner in response to specific water supply circumstances.

It is an object of this invention, therefore, to overcome the aforementioned problems of the prior art, namely by allowing in a simple, fast, reliable, flexible, effective and efficient way to dynamically control supply of water at customer sites at least on the basis of customer profiles taking into account the conditions of the water distribution network.

### SUMMARY OF INVENTION

It is specific subject-matter of the present invention a water meter, configured to supply water at a customer site, including:
a water flow regulating valve configured to assume at least three predetermined positions including a fully open position configured to let a maximum water flow to be supplied at said customer site, a closed position configured to prevent water flow to be supplied at said customer site, and at least one intermediate position configured to let at least one respective intermediate water flow, lower than the maximum water flow, to be supplied at said customer site;
an actuator operatively coupled to the water flow regulating valve and configured to automatically set a current position of the water flow regulating valve selected out of said at least three predetermined positions;
a pressure sensor configured to detect water pressure upstream of the water flow regulating valve;
a processing and communicating unit, operatively connected to the actuator, that is configured to communicate with a remote water provider centre to receive water flow regulating valve setting data, wherein said processing and communicating unit is further operatively connected to said pressure sensor to receive water pressure data sensed by said pressure sensor;

wherein said processing and communicating unit is configured to control the actuator to cause the water flow regulating valve to assume said current position corresponding to valve position setting data that are correlated to said water flow regulating valve setting data and to said water pressure upstream of said water flow regulating valve detected by said pressure sensor, wherein said water flow regulating valve setting data are in turn correlated to a customer profile.

According to a further aspect of the invention, said customer profile may comprise one or more data selected from the group comprising billing data, a priority indicator, a location, consumption data, contractual data and plant data.

According to a further aspect of the invention, said processing and communicating unit may be configured to send said water pressure data sensed by said pressure sensor to the remote water provider centre, wherein said water flow regulating valve setting data are further correlated to said at least part of said water pressure data sensed by said pressure sensor, wherein said valve position setting data correspond to said water flow regulating valve setting data received from said remote water provider centre, thereby said valve position setting data are further correlated to said at least part of said water pressure data sensed by said pressure sensor through correlation of said water flow regulating valve setting data to said at least part of said water pressure data.

According to another aspect of the invention, said processing and communicating unit may be configured to determine said valve position setting data on the basis of both said water flow regulating valve setting data received from said remote water provider centre and said at least part of said water pressure data sensed by said pressure sensor.

According to an additional aspect of the invention, said water flow regulating valve setting data may include or consist of a target maximum water flow rate setpoint, thereby said valve position setting data are correlated to said target maximum water flow rate setpoint and said at least part of said water pressure data.

According to a further aspect of the invention, said water pressure data may include or consist of a current water pressure, and said processing and communicating unit may be configured to determine said current position of the water flow regulating valve by means of a look-up table stored in said processing and communicating unit, wherein said look-up table includes a set of positions of the water flow regulating valve each corresponding to a respective valve position setting data consisting of a pair of target maximum water flow rate setpoint and current water pressure.

According to an additional aspect of the invention, said pressure sensor may be configured to detect water pressure upstream of the water flow regulating valve periodically, wherein said processing and communicating unit is optionally configured to estimate a water static pressure upstream of the water flow regulating valve.

According to another aspect of the invention, said processing and communicating unit may be configured to issue an alert and to control the actuator to set said current position of the water flow regulating valve at the closed position when said water pressure data correspond to a first alert condition, wherein the water meter optionally further includes a push button configured to acknowledge said alert and to cause said processing and communicating unit to control the actuator to change said current position of said water flow regulating valve from said closed position. For instance, such first alert condition may occur when the value of the water pressure is either exceeding a maximum pressure threshold or below a minimum pressure threshold (e.g., in the case where water pressure is outside a pressure range that is admissible for the proper operation of the water meter when no leakage is present in the area of the water distribution network to which the water meter belongs).

According to a further aspect of the invention, said processing and communicating unit may be configured to issue an alert and to control the actuator to set said current position of the water flow regulating valve at the closed position when said water flow regulating valve setting data correspond to a second alert condition, wherein the water meter optionally further includes a push button configured to acknowledge said alert and to cause said processing and communicating unit to control the actuator to change said current position of said water flow regulating valve from said closed position. For instance, such second alert condition may occur when the customer has not duly payed long outstanding overdue payments despite several dunning notices, or when the area of the water distribution network to which the water meter belongs is affected by works or leakage).

According to another aspect of the invention, wherein said water flow regulating valve setting data may include or consist of said current position of the water flow regulating valve.

According to an additional aspect of the invention, said processing and communicating unit may be configured to bidirectionally communicate with the remote water provider centre through a Low-Power Wide-Area (LPWAN) bidirectional communication network, optionally through a Narrowband Internet of Things (NB-IoT) bidirectional communication network, more optionally according to an encrypted communication protocol.

It is further specific subject-matter of the present invention a system of monitoring water supply at a plurality of customer sites, including a remote water provider centre and a plurality of water meters each located at a respective customer site, wherein each water meter is the water meter as previously described, thereby the processing and communicating unit of each water meter is configured to communicate with the remote water provider centre, wherein the remote water provider centre comprises a processing device configured to determine said water flow regulating valve setting data correlated to the customer profile.

It is still specific subject-matter of the present invention a computer-implemented method of dynamically controlling a water supply at a customer site, including the following steps:
A. having a customer profile;
B. detecting water pressure upstream of a water flow regulating valve at said customer site to provide water pressure data;
C. determining water flow regulating valve setting data correlated to a customer profile; and
D. automatically setting a current position of said water flow regulating valve that correspond to valve position setting data that are correlated to said water flow regulating valve setting data and to said water pressure detected upstream of said water flow regulating valve, wherein said current position is selected out of at least three predetermined positions that the water flow regulating valve is configured to assume and that include a fully open position configured to let a maximum water flow to be supplied at said customer site, a closed position configured to prevent water flow to be supplied at said customer site, and at least one intermediate position configured to let at least one respective intermediate water flow, lower than the maximum water flow, to be supplied at said customer site.

In particular, “having a customer profile” may mean either determining a customer profile, receiving a customer profile or retrieving a customer profile from a database.

It is another specific subject-matter of the present invention a set of one or more computer programs comprising instructions which, when executed by a processing and communicating unit of a water meter and a processing device of a remote water provider centre, cause said processing and communicating unit and said processing device to carry out the computer-implemented method of dynamically controlling a water supply at a customer site as previously described.

It is an additional specific subject-matter of the present invention a set of one or more computer-readable storage media having stored thereon the set of one or more computer programs just described.

The advantages offered by the invention are numerous and significant.

In fact, the water meter allows to dynamically control the supply of water at a customer site by means of a water flow regulating valve that is configured to assume any of a fully open position (configured to let a maximum water flow to be supplied at said customer site), a closed position (configured to prevent water flow to be supplied at said customer site) and at least one intermediate position configured to let at least one respective intermediate water flow. The water meter flow regulating valve includes an actuator configured to automatically set the water flow regulating valve at a current position that corresponds to valve position setting data that are correlated to water flow regulating valve setting data received by the water meter from a remote water provider centre, wherein the water flow regulating valve setting data are in turn correlated to a customer profile. In other words, the water flow regulating valve is actuated on the basis of a remote control.

Such remote control (namely the current position of the water flow regulating valve) may be easily correlated also to a combination of parameters measured at the consumption site, in particular pressure (and/or even flow rate and/or flow volume), by means of a software component executed at least in part at the remote water provider centre. In particular, water pressure data may be used to properly set the position of the water flow regulating valve, e.g. when the water flow regulating valve setting data includes or consists of a target maximum water flow rate setpoint and the flow rate depends on both valve aperture and water pressure; also, water pressure data received from a plurality of water meter installed at different locations on the water distribution network can be used to find an area affected by a possible leakage.

Optionally, a LPWAN bidirectional communication offering end-to-end IoT connectivity solution ensures the data transmission between the remote water provider centre and the water meter at the customer site.

The water meter allows to implement a smart system of monitoring water supply at a plurality of customer sites, wherein a remote water provider centre is configured to communicate with each one of a plurality of water meters according to the invention at respective customer sites, wherein the remote water provider centre is optionally configured to execute an advanced software to calculate the maximum water flow rates setpoints to be applied at respective water meters of the system by setting the corresponding current positions of the related water flow regulating valves.

The invention allows to carry out advanced water flow control functions at a customer site, wherein the current position of the related water flow regulating valve is automatically set on the basis of valve position setting data that are correlated to water flow regulating valve setting data received by the water meter from a remote water provider centre, wherein the water flow regulating valve setting data are in turn correlated to a customer profile and to the water pressure upstream of the water flow regulating valve detected by a pressure sensor (possibly through a correlation to at least part of water pressure data sensed by the pressure sensor) with which the water meter is provided.

### BRIEF DESCRIPTION OF THE DRAWINGS

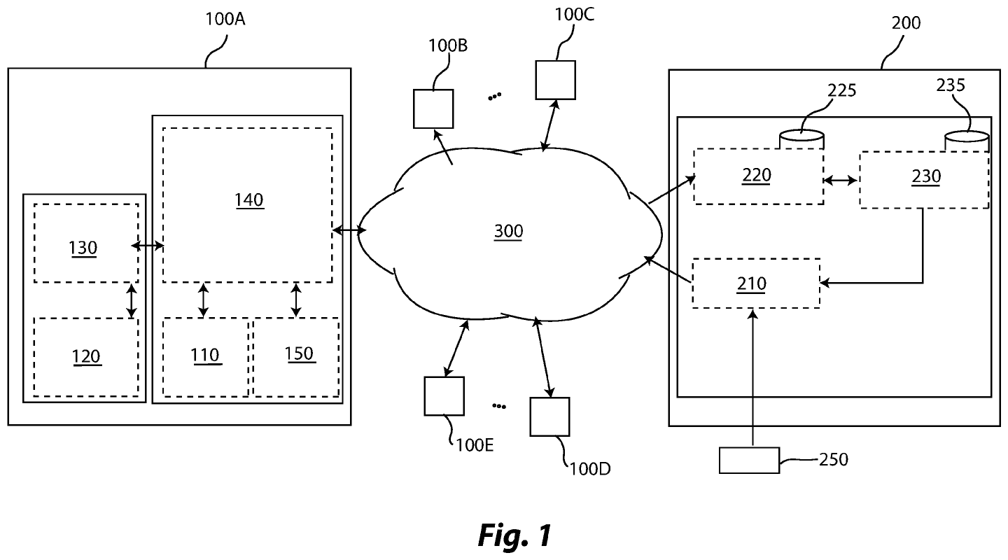

The present invention will be now described, by way of illustration and not by way of limitation, according to its preferred embodiments, by particularly referring to FIG. 1 of the annexed drawings, showing a schematic block diagram of a preferred embodiment of the system of monitoring water supply at a plurality of customer sites, including a remote water provider centre and a plurality of water meters according to the invention.

### DETAILED DESCRIPTION OF THE INVENTION

With reference to FIG. 1, it may be observed that a preferred embodiment of the system of monitoring water supply at a plurality of customer sites includes a plurality of water meters according to the invention, five of which are shown and indicated by reference numerals 100A, 1008, 100C, 100D and 100E.

Each water meter is installed to supply water at a respective customer site and is connected to a remote water provider centre 200 through a communication network 300, that in the preferred embodiment of the water supply monitoring system comprises the Internet.

FIG. 1 shows in detail only the arrangement of water meter 100A, as described in the following, but it should be understood that the other water meters 1008, 100C, 100D and 100E have similar arrangements.

The water meter 100A conventionally includes a metering device 110 configured to measure the amount of water supplied at the customer site. The metering device 110 is based on mechanical and/or electronic technology and optionally employs a flow rate sensor configured to measure the flow rate of water supplied at the customer site.

The water meter 100A also includes a water flow regulating valve 120 configured to assume at least three predetermined positions including:
a fully open position, configured to let a maximum water flow to be supplied at said customer site,
a closed position configured to prevent water flow to be supplied at said customer site, and
at least one intermediate position configured to let at least one respective intermediate water flow, lower than the maximum water flow, to be supplied at said customer site; optionally, the water meter 100A may have three or four intermediate positions, each one corresponding to a respective intermediate water flow that is different from those of the other intermediate positions.

Optionally, the water flow regulating valve 120 is a mechanical and/or electromechanical valve including or consisting of one or more of ball valves, butterfly valves, needle valves, diaphragm valves, gate valves and plug valves.

Furthermore, the water meter 100A includes an actuator 130 operatively coupled to the water flow regulating valve 120 and configured to automatically set the position of the water flow regulating valve 120 among the (at least three) predetermined positions.

The water meter 100A also includes a processing and communicating unit 140 that is operatively connected to the metering device 110 and to the actuator 130. The processing and communicating unit 140 is configured to control the actuator 130 to set the position of the water flow regulating valve 120. Conventionally, the processing and communicating unit 140 is configured to receive measurement data from the metering device 110 and to check and/or control the operation thereof.

The processing and communicating unit 140 is configured to communicate with the remote water provider centre 200 through the communication network 300. In particular, the remote water provider centre 200 includes a processing device 210 that is configured to send water flow regulating valve setting data to the processing and communicating unit 140, wherein the water flow regulating valve setting data are correlated to a customer profile corresponding to the customer site where the water meter 100A is installed. In turn, the processing and communicating unit 140 determines and sends valve position setting data to the actuator 130 to control the latter to set the position of the water flow regulating valve 120, wherein the valve position setting data are correlated to said water flow regulating valve setting data.

The customer profile may comprise one or more of the following:
billing data of the customer concerned, such as possible presence of overdue payments and related delays for the customer concerned;
a priority indicator of the customer concerned, optionally indicating any obligation on the water provider not to interrupt the water supply (as in the case where the water supply is installed at a sensitive site, such as a hospital or prison) and/or a level of tolerability of an interruption of the water supply; for instance, interruptions may be progressively less tolerable according to the following series of customer sites: a single residential apartment (where interruptions are the most tolerable), a residential condominium; a public administration office or restaurant; a school or university; a medical office; a factory; a hospital or prison (where interruptions are the least tolerable);
a location of the customer site, for instance in terms of GPS data and/or in terms of position in the water distribution network;
consumption data of the customer site;
contractual data of the customer concerned, such as type of contract and/or type of customer; and
plant data of the customer site, such as the diameter of the water carrying conduit through which the water meter supplies water at the customer site.

The remote water provider centre 200 also includes a MDM (Meter Data Management) system 220, provided with a measurement database 225, and a CRM (Customer Relationship Management) and billing system 230, provided with a customer database 235, which are connected or connectable to each other. The processing device 210 is connected or connectable with both the MDM system 220 and the CRM and billing system 230. In particular, the remote water provider centre 200 may be implemented either at a single site by means of one or more servers connected to each other or through a cloud system of geographically distributed servers connected to each other. It must be noted that in other embodiments of the present invention the MDM system 220 and the CRM and billing system 230 may be integrated into a single system, and/or the measurement database 225 and the customer database 235 may be integrated into a single database.

The MDM system 220 receives, through the communication network 300, the measured data from each one of the plurality of water meters 100A, 1008, 100C, 100D and 100E and it stores them in the measurement database 225 in association with the respective water meter (and/or with the respective customer and/or customer site).

The CRM and billing system 230 stores in the customer database 235 data related to the customer and customer site where each one of the plurality of water meters 100A, 1008, 100C, 100D and 100E is installed; furthermore, the CRM and billing system 230 receives customer consumption data from the MDM system 220 to generate and store billing data associated with the respective customer and customer site in the customer database 235.

In other words, for the customer profile corresponding to the customer site where each one of the plurality of water meters 100A, 1008, 100C, 100D and 100E is installed, the measurement database 225 and the customer database 235 store data of the customer profile related to each; namely, the measurement database 225 stores consumption data, while the customer database 235 may store one or more out of billing data, priority indicator, location, contractual data and plant data.

The processing device 210 is configured to receive from the MDM system 220 and the CRM and billing system 230 the customer profile. Furthermore, the processing device 210 is connected to an interface module 250 from which it is configured to receive environmental data, such as weather and weather forecast data, possible leakage data on leakages in the water distribution network, event data on possible events affecting the water supply in the water distribution network. The interface module 250 may include one or more manual interface devices (such as a keyboard), one or more communication devices (some of which can be connected to sensors distributed along the water distribution network), one or more sensing devices (such as one or more cameras, one or more weather sensors, one or more temperature and/or humidity sensors).

The processing device 210 is also configured to generate water flow regulating valve setting data correlated to the customer profile, and possibly to the environmental data received from the interface module 250. Moreover, the processing device 210 is configured to send, through the communication network 300, the thus generated water flow regulating valve setting data to the processing and communicating unit 140 of the water meter corresponding to the customer and customer profile concerned (as shown in FIG. 1 with reference to the water meter 100A).

In this way, the remote water provider centre 200 is configured to control the position of the water flow regulating valve 120 of the water meter 100A on the basis of the customer profile and possibly of specific circumstances occurring in the environmental context, including both the specific customer site where the water meter 100A is installed and at least part of the water distribution network to which the water meter 100A belongs. Some examples of monitoring the water supply, including such remote control, will be given later.

The water meter 100A according to the invention also includes a pressure sensor 150 configured to detect water pressure upstream of the water flow regulating valve 120, wherein said processing and communicating unit 140 is operatively connected to the pressure sensor 150 to receive water pressure data sensed by the pressure sensor 150. In this case, the valve position setting data are advantageously further correlated to at least part of said water pressure data sensed by the pressure sensor 150; for instance, the valve position setting data can be correlated to a specific water pressure data sensed at a specific time, or to a pressure average along a time window preceding a certain time, or to a trend (i.e. a derivative in time) of the pressure data. Advantageously, the water pressure data sensed by the pressure sensor 150 are used to adjust the position of the water flow regulating valve 120 as a function of a target maximum flow rate and water pressure.

In a first arrangement, the processing and communicating unit 140 may be configured to send the water pressure data sensed by the pressure sensor 150 to the remote water provider centre 200, namely through the communication network 300 to the MDM system 220 that stores them in the measurement database 225 in association with the respective water meter (and/or with the respective customer and/or customer site). In this case, the processing device 210 is configured to receive from the MDM system 220 also at least part of said water pressure data sensed by the pressure sensor 150 and to generate the water flow regulating valve setting data correlated to both the customer profile and said at least part of said water pressure data (and possibly to the environmental data received from the interface module 250) and the valve position setting data correspond to the water flow regulating valve setting data received by the processing and communicating unit 140 from the processing device 210 of the remote water provider centre 200. In other words, the valve position setting data are correlated to both the customer profile and said at least part of said water pressure data (and possibly to the environmental data received from the interface module 250) through the correlation of said water flow regulating valve setting data to both the customer profile and said at least part of said water pressure data (and possibly to the environmental data received from the interface module 250). In particular, said part of said water pressure data may include or consist of a single water pressure, e.g. a current (or a mean) water pressure, and the processing device 210 may be configured to generate the water flow regulating valve setting data as coinciding with the position of the water flow regulating valve 120 (or the valve position setting data) by means of a look-up table stored in the processing device 210, wherein said look-up table includes a set of positions of the water flow regulating valve 120 each corresponding to a respective valve position setting data consisting of a pair of customer profile data and current (or mean) water pressure. Optionally, the processing and communicating unit 140 may be configured to issue an alert and to control the actuator 130 to set the position of the water flow regulating valve 120 at the closed position when the water flow regulating valve setting data correspond to an alert condition; in this case, the water meter 100A may further include a push button configured to acknowledge said alert and to cause the processing and communicating unit 140 to control the actuator 130 to change the position of the water flow regulating valve 120 from said closed position.

Alternatively, in a second arrangement, the processing and communicating unit 140 determines the valve position setting data on the basis of both the water flow regulating valve setting data (correlated to the customer profile and possibly to the environmental data received from the interface module 250) received from the processing device 210 of the remote water provider centre 200 and at least part of said water pressure data sensed by the pressure sensor 150 and received therefrom. Thereby, the valve position setting data are correlated to both the customer profile and said at least part of said water pressure data (and possibly to the environmental data received from the interface module 250). In particular, the water flow regulating valve setting data may include or consist of a target maximum water flow rate setpoint; in other words, the valve position setting data may be correlated to such target maximum water flow rate setpoint and said at least part of said water pressure data. In this case, said part of said water pressure data may include or consist of a single water pressure, e.g. a current (or a mean) water pressure, and the processing and communicating unit 140 may be configured to determine the current position of the water flow regulating valve 120 (or the valve position setting data) by means of a look-up table stored in the processing and communicating unit 140, wherein said look-up table includes a set of positions of the water flow regulating valve 120 each corresponding to a respective valve position setting data consisting of a pair of target maximum water flow rate setpoint and current (or mean) water pressure. Optionally, the processing and communicating unit 140 may be configured to issue an alert and to control the actuator 130 to set the position of the water flow regulating valve 120 at the closed position when the water pressure data sensed by the pressure sensor 150 correspond to an alert condition; similarly to what illustrated above, the water meter 100A may include a push button configured to acknowledge said alert and to cause the processing and communicating unit 140 to control the actuator 130 to change the position of the water flow regulating valve 120 from said closed position.

Optionally, the processing and communicating unit 140 of the water meter 100A can communicate with the processing device 210 of the remote water provider centre 200 the send and/or receive data periodically, e.g. once per day.

Optionally, power for the electronic components of the water meter 100A is supplied by at least one battery, more optionally including at least one rechargeable battery, housed in a compartment of the water meter 100A; in particular, the electronic components of the water meter 100A include the processing and communicating unit 140, the actuator 130 and the pressure sensor 150, as well as the metering device 110 when this is based on electronic technology and the water flow regulating valve 120 when this is an electromechanical valve. In this way, the water meter 100A is provided with an autonomous power supply enabling the electronic components to properly operate. To extend the battery autonomy, the electronic components of the water meter 100A may operate according to appropriate operating modes, such as, for instance, in the case the exchange of data between the processing and communicating unit 140 of the water meter 100A and the processing device 210 of the remote water provider centre 200 occurs periodically and/or upon specific events like intensive use of water at the customer site over a long period of time or major leakages in the area of the water distribution network to which the water meter belongs.

The communication network 300 advantageously provides low-power, long-range, secure and two-way communication, allowing for reliable indoor coverage capability under difficult radio propagation conditions (wherein the water meters can be buried or semi-buried). In particular, the communication network 300 can be a Low-Power Wide-Area (LPWAN) bidirectional communication network, optionally through a Narrowband Internet of Things (NB-IoT) bidirectional communication network, more optionally according to an encrypted communication protocol to ensure the secured transmission of sensitive customer data. Communications from water meters to gateways of the LPWAN can be carried out in broadcast mode, allowing multiple gateways to receive the same communication from a single water meter.

Some examples of monitoring the water supply by means of the system according to the invention, allowing for a remote control of the water meters (100A, 100B, 100C, 100D, 100E) by the remote water provider centre 200, are given in the following.

In a first example, a customer in a single residential apartment with a domestic contract, without any “non-interruption” obligation on the water provider (i.e. the customer profile has not a high priority indicator), could be interested in a flow rate reduction in case of need due to periods of water shortage. The customer concerned could be selected either because he/she is within a specific geographical area (in this case the customer database 235 stores the location of the water meter), such as a municipality (for ease of management of communications with citizens regarding water reductions) or because he/she belongs to a specific aqueduct system supplying that customer water meter (to optimize the water distribution from the specific aqueduct). Then, the processing device 210 of the remote water provider centre 200 generates water flow regulating valve setting data taking account of the historical data of pressure and flow rate at the water meter and the water meter diameter. The processing and communicating unit 140 of the water meter controls the actuator 130 to cause the water flow regulating valve 120 to assume a position corresponding to such valve position setting data that are correlated to the water flow regulating valve setting data, i.e. to the historical data of pressure and flow rate and the water meter diameter.

In a second example, a customer is a residential condominium, having a certain number of domestic, without any “non-interruption” obligation on the water provider (i.e. the customer profile has not a high priority indicator). The customer could be a bad payer, i.e. long outstanding overdue payment(s) are stored in the customer database 235 for that customer. Then, the processing device 210 of the remote water provider centre 200 generates water flow regulating valve setting data taking account of the historical data of pressure and flow rate at the water meter, the water meter diameter and the total number of users served by the water meter. The processing and communicating unit 140 of the water meter controls the actuator 130 to cause the water flow regulating valve 120 to assume a position corresponding to such valve position setting data that are correlated to the water flow regulating valve setting data, that is to the historical data of pressure and flow rate at the water meter, the water meter diameter and the total number of users served by the water meter. Also, the processing device 210 of the remote water provider centre 200 could generate such valve position setting data which are correlated to a determination of a value of the water flow rate delivered daily by the water meter and/or of a maximum water volume delivered daily by the water meter, on the basis of the total number of users served by the residential condominium water meter, beyond which maximum water volume the processing device 210 generates valve position setting data to cause the position of the water flow regulating valve 120 to be set at the closed position (i.e. the water flow regulating valve 120 is completely shut off).

In a third example, a customer is an individual customer living in a house with a domestic contract, without any “non-interruption” obligation on the water provider (i.e. the customer profile has not a high priority indicator). On the basis of the location of the water meter (that is stored in the customer database 235) and of the (daily) consumption data measured at the water meter (and stored in the measurement database 225), the processing device 210 of the remote water provider centre 200 triggers an alert because:
the customer is in a hydraulic zone impacted by a water shortage; and/or
it detects a regular use of the watering garden system (intensive use of water over a long period of time).

In response, the processing device 210 generates water flow regulating valve setting data so that the processing and communicating unit 140 of the water meter controls the actuator 130, possibly taking account of the local water pressure sensed by the pressure sensor 150, to cause the water flow regulating valve 120 to assume an intermediate position according to a water flow reduction (e.g. 10 to 12 litres/minute), which is sufficient to ensure basic domestic uses including baths and showers but not sufficient for intensive water uses like watering the garden. In this case, the water flow regulating valve setting data can include (or correspond to) an alert to be issued at the water meter, namely by the processing and communicating unit thereof.

In a fourth example, a customer is an individual customer living in a house with a domestic contract, without any “non-interruption” obligation on the water provider (i.e. the customer profile has not a high priority indicator). On the basis of the billing data (stored in the customer database 235), the customer is flagged as a bad payer due to long outstanding overdue payment(s) or late payment(s) despite several dunning notices. An alert is therefore generated in the central IT software. The processing device 210 of the remote water provider centre 200 generates water flow regulating valve setting data so that the processing and communicating unit 140 of the water meter controls the actuator 130, possibly taking account of the local water pressure sensed by the pressure sensor 150, to cause the water flow regulating valve 120 to assume an intermediate position according to a water flow reduction to limit the water flow significantly (e.g. down to 3 to 4 litres/minute) to ensure only essential needs (hand washing, drinking, operating dishwasher or washing machine) but making showering and simultaneous water uses more difficult. After a given period of time, if the overdue payment(s) is(are) still not paid, beyond a threshold volume of water supplied daily by the water meter (e.g. 50 litres per person per day), the processing device 210 generates valve position setting data to cause the position of the water flow regulating valve 120 to be set at the closed position (i.e. the water flow regulating valve 120 is completely shut off). Also in this case, the water flow regulating valve setting data can include (or correspond to) an alert to be issued at the water meter, namely by the processing and communicating unit thereof.

In a fifth example, a customer is an individual customer living in a house with a domestic contract, without any “non-interruption” obligation on the water provider (i.e. the customer profile has not a high priority indicator). On the basis of the past consumption data measured at the water meter (and stored in the measurement database 225), a major leakage is detected by the processing device 210 of the remote water provider centre 200, e.g. triggered by a continuous consumption flow higher than 60 litres/hour (which is not due to the filling of a swimming pool). The processing device 210 of the remote water provider centre 200 generates water flow regulating valve setting data causing an alert to be issued at the water meter (and possibly an alert is also sent to a device of the customer, such as a smartphone) to inform the customer, and possibly to propose to apply a setpoint of “water flow reduction” or “water cut-off”. If the customer agrees and a related response signal is sent to the processing device 210 by means of the interface module 250, the processing device 210 of the remote water provider centre 200 generates water flow regulating valve setting data so that the processing and communicating unit 140 of the water meter controls the actuator 130, possibly taking account of the local water pressure sensed by the pressure sensor 150, to cause the water flow regulating valve 120 to assume either an intermediate position according to a water flow reduction to limit the water flow significantly or the closed position (i.e. the water flow regulating valve 120 is completely shut off). In any case, it must be noted that issuing of an alert at the water meter (and the possible alert also sent to a device of the customer) is not an essential feature for the invention.

The preferred embodiments of this invention have been described and a number of variations have been suggested hereinbefore, but it should be understood that those skilled in the art can make variations and changes, without so departing from the scope of protection thereof, as defined by the attached claims.

1. A water meter, configured to supply water at a customer site, including:
a water flow regulating valve configured to assume at least three predetermined positions including a fully open position configured to let a maximum water flow to be supplied at said customer site, a closed position configured to prevent water flow to be supplied at said customer site, and at least one intermediate position configured to let at least one respective intermediate water flow, lower than the maximum water flow, to be supplied at said customer site;
an actuator operatively coupled to the water flow regulating valve and configured to automatically set a current position of the water flow regulating valve selected out of said at least three predetermined positions;
a pressure sensor configured to detect water pressure upstream of the water flow regulating valve;
a processing and communicating unit, operatively connected to the actuator, that is configured to communicate with a remote water provider centre to receive water flow regulating valve setting data, wherein said processing and communicating unit is further operatively connected to said pressure sensor to receive water pressure data sensed by said pressure sensor;
wherein said processing and communicating unit is configured to control the actuator to cause the water flow regulating valve to assume said current position corresponding to valve position setting data that are correlated to said water flow regulating valve setting data and to said water pressure upstream of said water flow regulating valve detected by said pressure sensor, wherein said water flow regulating valve setting data are in turn correlated to a customer profile.

2. The water meter according to claim 1, wherein said processing and communicating unit is configured to send said water pressure data sensed by said pressure sensor to the remote water provider centre, wherein said water flow regulating valve setting data are further correlated to said at least part of said water pressure data sensed by said pressure sensor, wherein said valve position setting data correspond to said water flow regulating valve setting data received from said remote water provider centre, thereby said valve position setting data are further correlated to at least part of said water pressure data sensed by said pressure sensor through correlation of said water flow regulating valve setting data to said at least part of said water pressure data.

3. The water meter according to claim 1, wherein said processing and communicating unit is configured to determine said valve position setting data on the basis of both said water flow regulating valve setting data received from said remote water provider centre and at least part of said water pressure data sensed by said pressure sensor.

4. The water meter according to claim 3, wherein said water flow regulating valve setting data include or consist of a target maximum water flow rate setpoint, thereby said valve position setting data are correlated to said target maximum water flow rate setpoint and said at least part of said water pressure data.

5. The water meter according to claim 4, wherein said water pressure data include or consist of a current water pressure, and wherein said processing and communicating unit is configured to determine said current position of the water flow regulating valve by means of a look-up table stored in said processing and communicating unit, wherein said look-up table includes a set of positions of the water flow regulating valve each corresponding to a respective valve position setting data consisting of a pair of target maximum water flow rate setpoint and current water pressure.

6. The water according to claim 1, wherein said pressure sensor is configured to detect water pressure upstream of the water flow regulating valve periodically.

7. The water meter according to claim 1, wherein said processing and communicating unit is configured to issue an alert and to control the actuator to set said current position of the water flow regulating valve at the closed position when said water pressure data correspond to a first alert condition.

8. The water meter according to claim 1, wherein said processing and communicating unit is configured to issue an alert and to control the actuator to set said current position of the water flow regulating valve at the closed position when said water flow regulating valve setting data correspond to a second alert condition.

9. The water meter according to claim 1, wherein said water flow regulating valve setting data include or consist of said current position of the water flow regulating valve.

10. The water meter according to claim 1, wherein said processing and communicating unit is configured to bidirectionally communicate with the remote water provider centre through a Low-Power Wide-Area (LPWAN) bidirectional communication network.

11. A system of monitoring water supply at a plurality of customer sites, including a remote water provider centre and a plurality of water meters, each located and configured to supply water at a respective customer site, wherein each water meter includes:
a water flow regulating valve configured to assume at least three predetermined positions including a fully open position configured to let a maximum water flow to be supplied at said customer site, a closed position configured to prevent water flow to be supplied at said customer site, and at least one intermediate position configured to let at least one respective intermediate water flow, lower than the maximum water flow, to be supplied at said customer site;
an actuator operatively coupled to the water flow regulating valve and configured to automatically set a current position of the water flow regulating valve selected out of said at least three predetermined positions;
a pressure sensor configured to detect water pressure upstream of the water flow regulating valve;
a processing and communicating unit, operatively connected to the actuator, that is configured to communicate with a remote water provider centre to receive water flow regulating valve setting data, wherein said processing and communicating unit is further operatively connected to said pressure sensor to receive water pressure data sensed by said pressure sensor;
wherein said processing and communicating unit is configured to control the actuator to cause the water flow regulating valve to assume said current position corresponding to valve position setting data that are correlated to said water flow regulating valve setting data and to said water pressure upstream of said water flow regulating valve detected by said pressure sensor, wherein said water flow regulating valve setting data are in turn correlated to a customer profile, thereby the processing and communicating unit of each water meter is configured to communicate with the remote water provider centre, wherein the remote water provider centre comprises a processing device configured to determine said water flow regulating valve setting data correlated to the customer profile.

12. A computer-implemented method of dynamically controlling a water supply at a customer site, including the following steps:
A. having a customer profile;
B. detecting water pressure upstream of a water flow regulating valve at said customer site to provide water pressure data;
C. determining water flow regulating valve setting data correlated to a customer profile; and
D. automatically setting a current position of said water flow regulating valve that correspond to valve position setting data that are correlated to said water flow regulating valve setting data and to said water pressure detected upstream of said water flow regulating valve, wherein said current position is selected out of at least three predetermined positions that the water flow regulating valve is configured to assume and that include a fully open position configured to let a maximum water flow to be supplied at said customer site, a closed position configured to prevent water flow to be supplied at said customer site, and at least one intermediate position configured to let at least one respective intermediate water flow, lower than the maximum water flow, to be supplied at said customer site.

13. A computer-implemented method according to claim 12, wherein said customer profile comprises one or more data selected from the group comprising billing data, a priority indicator, a location, consumption data, contractual data and plant data.

14. A set of one or more computer programs comprising instructions which, when executed by a processing and communicating unit of a water meter and a processing device of a remote water provider centre, cause said processing and communicating unit and said processing device to carry out the computer-implemented method of dynamically controlling a water supply at a customer site including the following steps:
A. having a customer profile;
B. detecting water pressure upstream of a water flow regulating valve at said customer site to provide water pressure data;
C. determining water flow regulating valve setting data correlated to a customer profile; and
D. automatically setting a current position of said water flow regulating valve that correspond to valve position setting data that are correlated to said water flow regulating valve setting data and to said water pressure detected upstream of said water flow regulating valve, wherein said current position is selected out of at least three predetermined positions that the water flow regulating valve is configured to assume and that include a fully open position configured to let a maximum water flow to be supplied at said customer site, a closed position configured to prevent water flow to be supplied at said customer site, and at least one intermediate position configured to let at least one respective intermediate water flow, lower than the maximum water flow, to be supplied at said customer site.

15. A set of one or more computer-readable storage media having stored thereon the set of one or more computer programs comprising instructions which, when executed by a processing and communicating unit of a water meter and a processing device of a remote water provider centre, cause said processing and communicating unit and said processing device to carry out a computer-implemented method of dynamically controlling a water supply at a customer site including the following steps:
A. having a customer profile;
B. detecting water pressure upstream of a water flow regulating valve at said customer site to provide water pressure data;
C. determining water flow regulating valve setting data correlated to a customer profile; and
D. automatically setting a current position of said water flow regulating valve that correspond to valve position setting data that are correlated to said water flow regulating valve setting data and to said water pressure detected upstream of said water flow regulating valve, wherein said current position is selected out of at least three predetermined positions that the water flow regulating valve is configured to assume and that include a fully open position configured to let a maximum water flow to be supplied at said customer site, a closed position configured to prevent water flow to be supplied at said customer site, and at least one intermediate position configured to let at least one respective intermediate water flow, lower than the maximum water flow, to be supplied at said customer site.

16. The water meter according to claim 1, wherein said processing and communicating unit is configured to estimate a water static pressure upstream of the water flow regulating valve.

17. The water meter according to claim 7, further including a push button configured to acknowledge said alert and to cause said processing and communicating unit to control the actuator to change said current position of said water flow regulating valve from said closed position.

18. The water meter according to claim 8, further including a push button configured to acknowledge said alert and to cause said processing and communicating unit to control the actuator to change said current position of said water flow regulating valve from said closed position.

19. The water meter according to claim 1, wherein said processing and communicating unit is configured to bidirectionally communicate with the remote water provider centre through a Narrowband Internet of Things (NB-IoT) bidirectional communication network.

20. The water meter according to claim 1, wherein said processing and communicating unit is configured to bidirectionally communicate with the remote water provider centre according to an encrypted communication protocol.
